(19) United States
(12) Patent Application Publication
(10) Pub. No.: US 2002/0072278 A1
(43) Pub. Date: Jun. 13, 2002

(54) Electric jack

(76) Inventor: Jang Wee Duck, Seoul (KR)

Correspondence Address: LEIGHTON K. CHONG, OSTRAGER CHONG & FLAHERTY (HAWAII), 841 BISHOP STREET, SUITE 1200, HONOLULU, HI, 96813, US

(21) Appl. No.: 09/949,457

(22) Filed: Sep. 10, 2001

(30) Foreign Application Priority Data
Dec. 12, 2000 (KR) 20-0214501

(51) Int. Cl. H01R 4/10

(52) U.S. Cl. 439/877

(57) ABSTRACT

The present invention relates to an electric jack, which can be electrically connected to a lead wire of a cable without peeling a sheath of the cable when electrically connecting the cable to a connecting object including a terminal pin, etc. The electric jack according to one aspect of the present invention comprises a fixing unit fixed at both ends of a cable, a connecting unit fixed so as to be electrically connected to a lead wire inside of the cable, and a holder unit for electrically connecting the cable to the connecting object. Convex and concave portions are formed on a contact surface of the connecting unit that is in contact with the cable so that the convex and concave portions can penetrate a sheath of the cable and be electrically connected to the lead wire inside of the cable when the connecting unit is bent. The electric jack according to another aspect of the present invention comprises a connecting unit electrically connected to the lead wire inside of a cable by penetrating a sheath of the cable with convex and concave portions formed on a contact surface of the connecting unit that is in contact with the cable, and a first fixing unit and a second fixing unit integrally formed to elongate both ends of the connecting unit for fixing connected portions of the cable to face with each other.

### CROSS REFERENCE TO RELATED APPLICATION

This application claims priority from foreign patent application having application number 20-0214501, filed Dec. 12, 2000, which is hereby incorporated by reference.

### FIELD OF THE INVENTION

The present invention relates to an electric jack, and in particular, to an electric jack, which can be electrically connected to a lead wire of a cable without peeling a sheath of the cable when electrically connecting the cable to a connecting object including a terminal pin, etc.

### BACKGROUND OF THE INVENTION

In general, an electric jack is fixed on a cable when electrically connecting the cable to a connecting object such as a terminal, etc. The electric jack comprises a fixing unit fixed at both ends of the cable, a connecting unit connected to a lead wire of the cable, and a holder unit inserted to the connecting object so as to be electrically connected.

However, the conventional electric jack described above can be electrically connected to the connecting unit at both ends of the cable only by peeling the cable and exposing the lead wire.

Since the process of peeling the cable is very complicated, work performance is deteriorated, and the lead wire inside of the cable is easily cut in the peeling process when the cable is slim such as a coil of a motor.

### SUMMARY OF THE INVENTION

It is, therefore, an object of the present invention to provide an electric jack, which can enhance work performance by fixing the cable to be electrically connected without peeling the cable.

It is another object of the present invention to provide an electric jack, which can electrically connect the cut cable, when cut, without peeling the cable and with convenience.

To achieve the above objects according to one aspect of the present invention, there is provided an electric jack comprising: a connecting unit fixed to be electrically connected to a lead wire inside of a cable; and a holder unit inserted to a connecting object for electrically connecting the connecting object to the cable, characterized by convex and concave portions formed on a contact surface of the connecting unit that is in contact with the cable so as to be electrically connected to the lead wire by penetrating a sheath of the cable.

To achieve the above objects according to another aspect of the present invention, there is provided an electric jack comprising: fixing unit fixed onto both ends of a cable; a connecting unit electrically connected to a lead wire inside of the cable by penetrating sheath of the cable with convex and concave portions formed on a contact surface of the connecting unit that is in contact with the cable, and a first fixing unit and a second fixing unit integrally formed to elongate both ends of the connecting unit for fixing connected portions of the cable to face with each other.

Here, it is preferable to form the convex and concave portions in an acute shape in the connecting unit.

### BRIEF DESCRIPTION OF THE DRAWINGS

The above and other objects, features and advantages of the present invention will become more apparent from the following detailed description when taken in conjunction with the accompanying drawings, in which:

FIG. 1 is a perspective view of an electric jack according to a first embodiment of the present invention;

FIG. 2 is a cross-sectional view of the electric jack illustrating a state of use according to the first embodiment of the present invention;

FIG. 3 is a perspective view of the electric jack according to a variation of the first embodiment of the present invention;

FIG. 4 is a perspective view of the electric jack according to a second embodiment of the present invention; and

FIG. 5 is a cross-sectional view of the electric jack illustrating a state of use according to the second embodiment of the present invention

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

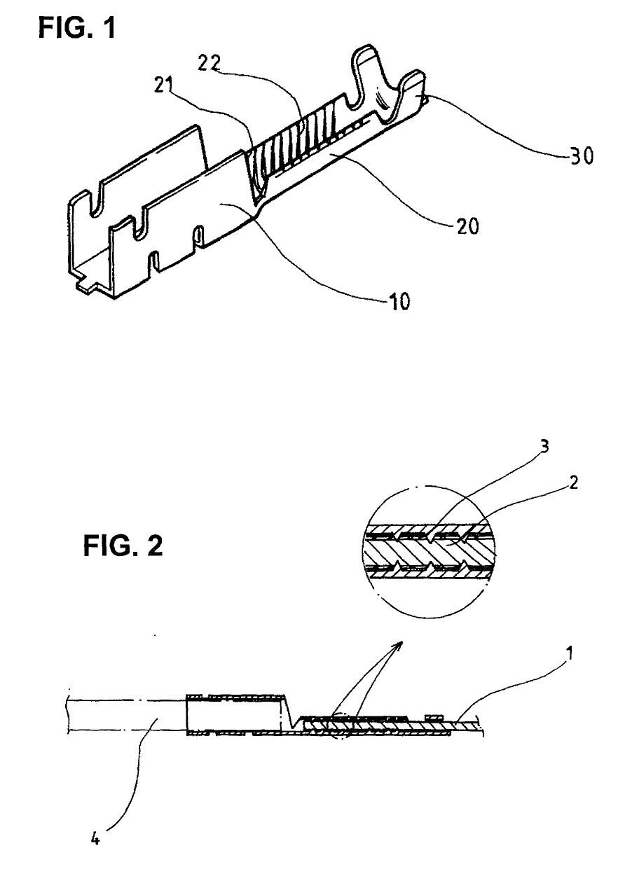

FIGS. 1 and 2 show a first embodiment of the present invention. The electric jack according to first embodiment of the present invention comprises a fixing unit 10 fixed at both ends of a cable 1, a connecting unit 20 electrically connected to a lead wire 2 inside of the cable 1, and a holder unit integrally formed for electrically connecting a connecting object 4 to the cable 1.

Convex and concave portions 22 are formed on a contact surface 21 of the contacting unit 20 that is in contact with the cable 1. The convex and concave portions 22 are electrically connected to the lead wire 2 by penetrating a sheath 3 of the cable 1 when the connecting unit 20 is bent.

Therefore, as specifically shown in FIG. 2, the convex and concave portions 22 are preferably formed in an acute shape so as to easily penetrate the sheath 3 of the cable 1.

According to the present invention constructed as above, end portions of the cable 1 are laid throughout the connecting unit 20 and the fixing unit 10 without peeling the sheath 3 of the cable 1. The fixing unit 10 is bent to fix the electric jack onto the cable 1.

Once the connecting unit 20 is bent, the convex and concave portions 22 formed on the contact surface 21 of the connecting unit 20 penetrate the sheath 3 to reach the lead wire 2 inside of the cable 1. Thus, the lead wire 2 of the cable 1 is electrically connected to the electric jack.

Therefore, the cable 1 is electrically connected to the connecting object 4 by inserting the holder unit 30 to the connecting object 4. Work performance is thus enhanced because the sheath 3 of the cable 1 is not peeled.

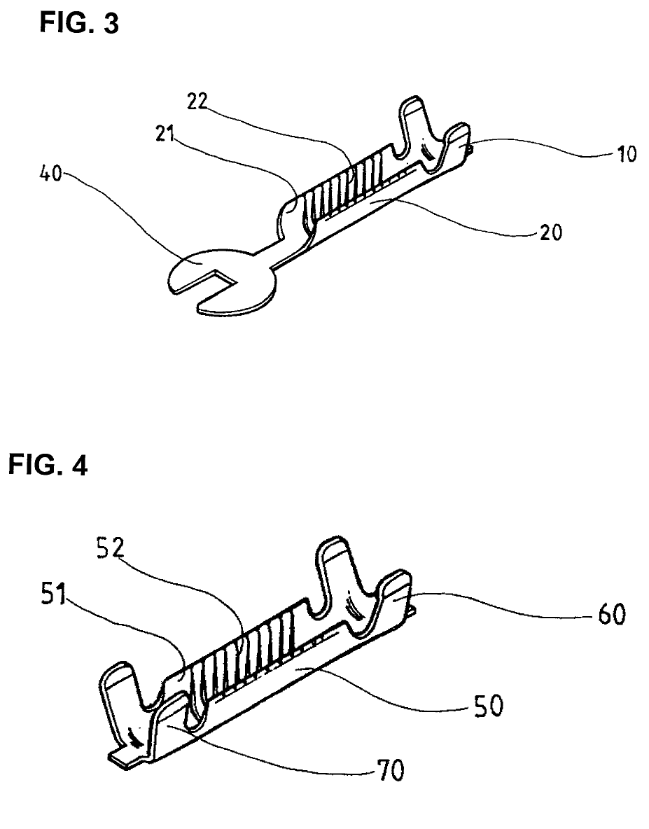

FIG. 3 shows an electric jack according to a variation of the first embodiment of the present invention. The fixing unit 10 and the connecting unit 20 are the same as the ones described with reference to FIG. 2. The holder unit 40 is formed in a ring shape. However, the shape of the holder unit 40 is not limited thereto but can be in any form if connectable to the connecting object 4.

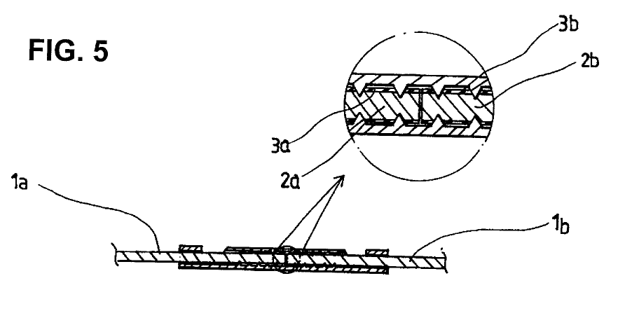

Meanwhile, FIGS. 4 and 5 show the electric jack according to the second embodiment of the present invention. The electric jack according to the second embodiment of the present invention comprises a connecting unit 50 electrically connected to the lead wire 2 of the cable 1, and a first fixing unit 60 and a second fixing unit 70 integrally fixed at both ends 1a, 1b of the cable 1 to elongate both ends of the connecting unit 50.

Convex and concave portions 52 are formed on a contact surface 51 of the connecting unit 50 that is in contact with cables 1a, 1b. The convex and concave portions 52 are electrically connected so as to be in contact with lead wires 2a, 2b inside of the cable by penetrating the sheaths 3a, 3b of the cables 1a, 1b when the connecting unit 50 is bent. The convex and concave portions 52 are preferably of an acute shape so as to easily penetrate the sheaths 3a, 3b.

The present invention constructed above has an advantage of easily connecting the cut middle portion of the cables 1a, 1b, when cut, as shown in FIG. 5. To be specific, the connecting portions of the cables 1a, 1b are laid throughout the first fixing unit 60 and the second fixing unit 70 as well as the connecting unit 50 to face with each other without peeling the sheaths 3a, 3b of the cables 1a, 1b. The electric jack is fixed at both connecting portions of the cables 1a, 1b by bending the first fixing unit 60 and the second fixing unit 70. If the connecting unit 50 at the center is subsequently bent, the convex and concave portions 52 formed on a contact surface 51 of the connecting unit 50 penetrates the sheaths 3a, 3b of the cables 1a, 1b to reach the lead wires 2a, 2b inside of the cables 1a, 1b. Then, the lead wires 2a, 2b are electrically connected to the electric jack, and the cut cables 1a, 1b are electrically connected again. By doing so, work performance is enhanced because the sheaths 3a, 3b of the cables 1a, 1b are not peeled.

As described above, the electric jack according to the present invention serves to enhance the work performance owing to no peeling of the sheath of the cable in electrically connecting the cable to a connecting object. The electric jack according to the present invention is also convenient in use because the cut cables can be electrically connected by facing the cables with each other without peeling the sheath.

While the invention has been shown and described with reference to a certain preferred embodiment thereof, it will be understood by those skilled in the art that various changes in form and details may be made therein without departing from the spirit and scope of the invention as defined by the appended claims.

1. An electric jack comprising:
a fixing unit fixed onto an end portion of a cable;
a connecting unit fixed to be electrically connected to a lead wire inside of a cable; and a holder unit inserted to a connecting object for electrically connecting the connecting object to the cable, characterized by convex and concave portions formed on a contact surface of the connecting unit that is in contact with the cable so as to be electrically connected to the lead wire by penetrating a sheath of the cable.

2. The electric jack of claim 1, wherein the convex and concave portions formed in the connecting unit are of an acute shape.

3. An electric jack comprising:
a connecting unit formed on a contact surface that is in contact with the cable so as to be electrically connected to a lead wire inside of a cable by penetrating the cable; and
a first fixing unit and a second fixing unit integrally formed to elongate both ends of the connecting unit for fixing connecting portions of the cable to face with each other.

4. The electric jack of claim 3, wherein the convex and concave portions formed on the connecting unit are of an acute shape.
